(19) United States
(12) Patent Application Publication
(10) Pub. No.: US 2019/0292011 A1
(43) Pub. Date: Sep. 26, 2019

(54) ELEVATOR CALL INPUT DEVICE

(71) Applicant: KONE Corporation, Helsinki (FI)

(72) Inventors: Klaus Mäkelä, Helsinki (FI); Ilia Kempi, Helsinki (FI)

(73) Assignee: KONE Corporation, Helsinki (FI)

(21) Appl. No.: 16/437,953

(22) Filed: Jun. 11, 2019

Related U.S. Application Data
(63) Continuation of application No. PCT/EP2017/051982, filed on Jan. 31, 2017.

(51) Int. Cl. B66B 1/52; B66B 1/46; B66B 1/34

(52) U.S. Cl. CPC B66B 1/52; B66B 1/468; B66B 2201/20; B66B 2201/10; B66B 1/3492

(57) ABSTRACT

A call input device of an elevator includes a keyboard for inputting the number of a floor and a keyboard control for the keyboard. The keyboard control is configured to open an input channel from the keyboard for the input of a further digit of a floor number to enter a more than one-digit floor number. The call input device includes a proximity sensor having a sensing area in front of the keyboard. The keyboard control is configured to open/close the input channel from the keyboard for the input of a further digit in response to the signal of the proximity sensor.

The present invention relates to a call input device of an elevator comprising a keyboard, e.g. a decade keyboard for inputting the number of a destination floor. The call input device has a keyboard control for the decade keyboard. After having received a first digit via the keyboard the keyboard control is configured to open an input channel from the keyboard for the input of a further digit of a destination floor number to enter more than one-digit destination floor number. Usually, such type of a call input device has for example a separate push button to indicate that a second digit of a destination floor number is to be input. Another known solution is the provision of a timer which keeps the input channel for the input of a further digit open for a predetermined time and when the timer has expired the inputted input digit(s) is/are transferred to the elevator control as a destination floor number. A third alternative is to set a maximum time frame for the pushing of the buttons.

The known solution is quite satisfactory. However, certain aged or handicapped people may require time to input two (or even three) digits in succession. Also first time users compared to experienced users need more time for the input of a floor number with several digits. Also focusing on some other things at the same time extends the feed time. Generally there are numerous conditions affecting user convenience for the input speed. In some cases this might lead to the registration of a destination call with one digit although the passenger would have intended to input a further digit.

It is therefore object of the invention to provide a call input device which better recognizes the intent of a passenger to input a one or several digit number for a destination floor.

The object is solved with a call input device according to claim 1 as well as with a method according to claim 6. Preferred embodiments of the invention are subject-matter of the dependent claims. Preferred embodiments are also described in the description and drawings of the present application.

According to the invention, the call input device comprises a proximity sensor having a sensor area in front of the decade keyboard. The keyboard control is configured to open the input channel from the keyboard for the input of a further digit of a destination floor number in response to the signal of the proximity sensor.

Accordingly, the call input device is able to consider for the evaluation whether a one, two or three digit destination floor number is to be inputted the behaviour of a passenger which is sensed by a proximity sensor in the front of the decade keyboard. Of course, also other info can be inputted via the keyboard, e.g. words or commands. A simple (and probable) implementation of the invention comprises the detection of the presence of a hand within the sensing area. When there is no hand, the input is set. (Digital yes/no information.). Anyway also the distance or a movement can be detected. The detection of the distance—e.g. as an analog value—requires a more advanced setup to detect the speed or direction of the hand. Usually, when the passenger wants to input a second or third digit, his hand for inputting the digit remains in the front of the decade keyboard which can be detected with the proximity sensor. However, if after the input of a digit, the proximity sensor senses that the hand is moving away from the proximity sensor and out of the sensing area it is deduced that the input of the destination floor number has been terminated. The call input device can then proceed to close the input channel and to issue the input digit(s) as destination floor number to the elevator control. Thus, the input of a one digit number can be accelerated with respect to the known timer based method. On the other hand, the passenger does not need to press a further key to input a second or third digit (in the seldom case that a building may have more than 100 destination floors). Therefore, the present invention provides a very reliable and efficient method of inputting one or several digit numbers in an elevator as destination floors.

Preferably, the proximity sensor is configured to sense the direction of a movement in the sensing area. In this case, the input channel for the input of a further digit is closed and the input digit is processed to the elevator control as destination floor number when the movement direction is sensed as being away from the keyboard. Via this feature, the elevator or the call input device is quite fast in recognizing that only one digit is intended to be input as a destination floor number.

Furthermore, the keyboard control preferably has a clock circuit which is triggered by pressing a button of the keyboard which keeps the input channel for the input of a further digit open as long as the proximity sensor keeps sensing an object in the sensing area. If the proximity sensor stops sensing an object in the sensing area, the input channel is immediately closed and the input digit is transferred to the elevator control as destination floor. If on the one hand the clock circuit has run a predetermined time, also the input channel is closed also when the hand of a passenger remains within the sensing area of the proximity sensor and the input digit is transmitted to the elevator control. Via this means, it can be prevented that the input channel for inputting a further digit keeps open without any limitation. This timeout should be considerably longer than conventional timeouts for input purposes in order to support the usability for different needs provided by proximity. Anyway, the pre-determined period of the clock circuit can be chosen longer as the current solutions as additionally the proximity sensor senses that a hand is still in the sensing area and so the input of a second or even third digit may be expected.

Preferably, the proximity sensor is arranged on a panel of the call input device where the keyboard is integrated. Via this measure, the proximity sensor is integrated in the overall outfit of the panel of the call input device and furthermore it can be ensured by this measure that the sensing area of the proximity sensor indeed covers the complete keyboard.

Preferably, the proximity sensor is located on the top of a panel of the call input device and the sensing area is downwards in front of the keyboard. This feature considers that usually the digit is input into the keyboard in a movement from downwards. Thus, the sensing area directed downwards is adapted to sense a typical movement for the inputting of a destination floor number.

Generally, the easiest way to sense is a digital input in terms of the presence or no presence of a hand. Second preferred way to measure is the object distance of the hand to the keypad. The determination off the direction and speed of the movement could be the result of the signal processing. Previous implementations can be performed by multiple available technologies (IR, light, temperature, ultrasonic, inductive, capacitive, RF). Having a sensor on top of the panel sensing downwards movements across field of view easily leads to application with camera or similar sensing.

Preferably, the elevator has an elevator control with a destination call control where the number of the destination floor is inputted not only in a car input device but also in the floor input devices. Of course, the call input device can also be used in continuous call control, of course then only inside the elevator car where the destination floor has to be entered.

In a further aspect of the invention, a method is provided for controlling a decade keyboard in a call control panel, preferably a destination call control panel having a decade keyboard. According to the invention after the input of a digit is sensed by a keyboard control, an input channel of the decade keyboard is controlled to be open/closed for the input of a further digit in response to sensor data of a proximity sensor having its sensing area in front of the keyboard. Via this measure, the sensor data from the proximity sensor can be taken into account in deciding whether or not a destination floor input shall be terminated after the input of only one digit or whether it shall be kept open to input a second (or even a third) digit. This method therefore provides a solution for a faster destination floor input for an elevator which does not need an additional button in the keyboard to indicate the input of a further digit for a destination floor number.

Preferably, the digit input for a destination floor is terminated when the proximity sensor senses an object, i.e. passenger hand, leaving the sensing area and the input digit is then transmitted as a destination floor number to an elevator control. Therefore, the input of only a one digit destination floor can be shortened by sensing that the hand inputting the destination floor number is drawn away from the keyboard area.

In a preferred embodiment of the invention, the digit input for receiving a destination floor is kept open for the input of a further digit when the proximity sensor senses an object remaining in the sensing area for a predefined time period. By this means, the call input device or the elevator is able to consider a movement of the passenger which apparently is intended to input a further digit as a destination floor number. Thus, the efficiency for inputting one and two (or even three) digits for inputting floor numbers for an elevator is more efficient and fast.

Preferably, the input channel for inputting a further digit is closed after the maximal allowed number of digits (a second or third or more digits) have been input, whereafter the inputted digits are combined to a floor number which is transferred via the keyboard control to the elevator control.

It is apparent that the keyboard control and the control of the call input device can be integrated with each other. The call input device regularly comprises further input/output devices as loudspeakers, microphones and illumination as well as emergency buttons.

In addition to conventional buttons and keypads the idea is useable with the touchscreens in the elevator field as well. On touch screens it is also possible to detect distance at certain levels already via the touch sensor of the display.

The proximity sensor could be an optical sensor, capacitive sensor or the like, which sensors are per se known in the art.

It shall be clear for the skilled person that the above-mentioned embodiments can be combined with each other arbitrarily.

Following terms are used as synonyms: operating panel—panel; call input device control—keyboard control;

The invention is hereinafter described by means of an example in connection with the drawings. In these drawings:

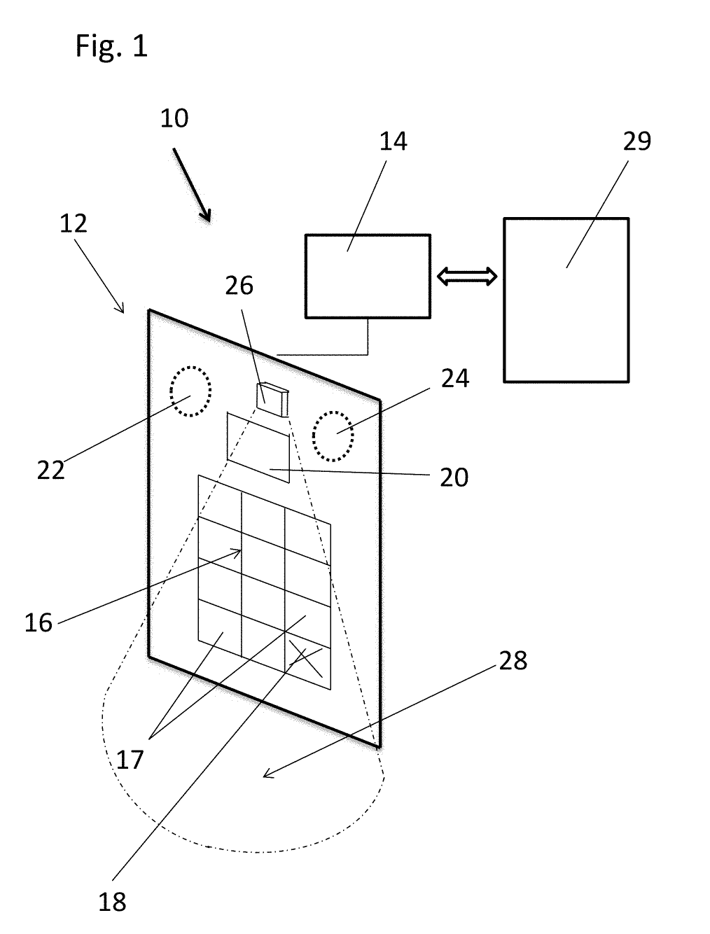

FIG. 1 shows a perspective view of a call input device connected to a keyboard control and an elevator control,

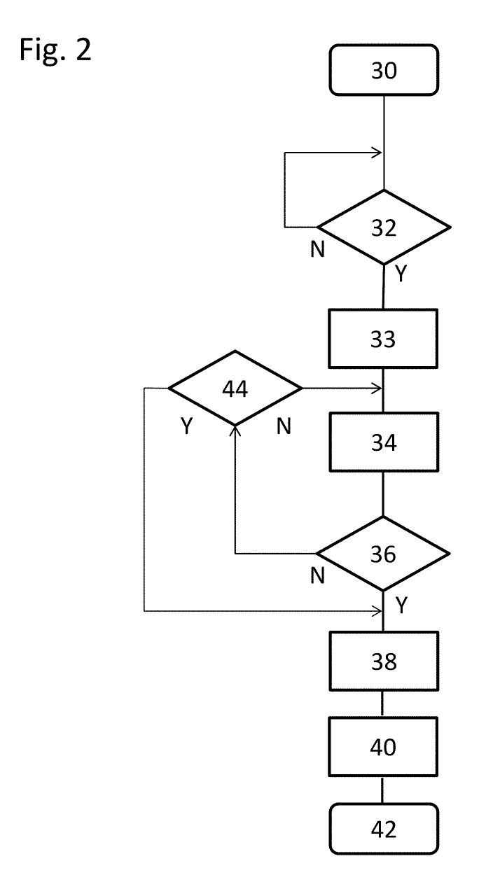

FIG. 2 a flow diagram for receiving a floor number for an elevator.

FIG. 1 shows a call input device 10, an operating panel 12 which is connected to a call input device control 14 which comprises the keyboard controller of a decade keyboard 16 arranged in the panel 12 of the call input device. Of course, the keyboard controller can be separate from the device controller. The decade keyboard 16 preferably has twelve buttons 17,18 with ten number digits 17 and two special buttons whereby one of these special buttons 18 may be an emergency button. Furthermore, the panel 12 comprises a display 20 for indicating floor data and/or other data, a microphone 22, a loudspeaker 24 whereby these devices can also be provided in a separate panel so that they do not need to be arranged in the panel 12 of the call input device. At the top of the panel 12, a proximity sensor 26 is located which has a sensing area 28 in front of the decade keyboard 16 and its respective push buttons (or touch sensitive buttons of a touch screen panel) 17. When a floor number is inputted into the decade keyboard 16, one number digit push button 17 is pressed and the signal of the proximity sensor 26 decides whether an input channel for inputting a further digit for a floor number is kept open in response to sensing an object, particularly a hand of a passenger in the sensing area 28. After the input is terminated, the floor number is transmitted from the call input device control 14 to an elevator control 29 for call allocation or processing.

The decade keyboard 16 as well as the display 20 can also be integrated as a combined touch screen panel according to recent developments.

FIG. 2 shows a flow diagram of a floor number input to operating panel 12 of the call input device of FIG. 1. The procedure starts at starting step 30. In the first deciding step 32 it is checked whether a digit has been inputted in the decade keyboard 16 or not. If the answer is no, the process is looped back to the beginning of decision step 32. If a push button 17 of the decade keyboard 16 has been pressed, the answer is yes and method proceeds to step 33 wherein a time-out timer is set and further to step 34 where the data of the proximity sensor 26 is read. In the second deciding step 36 it is decided whether an object (the hand of the passenger) moves away from the sensing area 28 of the proximity sensor or isn't present any longer in the sensing area. If this is the case, the input channel for the input of a floor number is closed in step 38 and the floor number is transmitted to the elevator control in step 40, whereafter the process stops in termination step 42.

If the hand is still present in the sensing area 26 (answer N) the second deciding step 36 branches to third deciding step 44 wherein it is checked whether or not the time-out timer 33 has reached its time-out value. If this is the case the third decision step 44 branches to step 38 to terminate input and transmit destination floor in steps 38 and 40. If the timer 33 hasn't reached the limit time value the third decision step 44 branches to digit input step 34 (reading the proximity sensor) from where it again goes to the second deciding step. In summary, the digit input is closed either when the time-out timer has indicated time-out or if the hand isn't any longer present in the sensing area 26.

Via this process, the input of multi digit numbers can be terminated faster and more reliable than in current solutions. The procedure has been described above with two digits. Of course, for high skyscrapers even three digit floor numbers can be given.

It is clear for the skilled person that the invention is not restricted to the explained embodiments but may be varied within the scope of the appended patent claims.

### LIST OF REFERENCE NUMBERS

10 Call input device
12 operating panel
14 call input device control
16 decade keyboard
17 digit push buttons
18 emergency push button
20 display
22 microphone
24 loudspeaker
26 proximity sensor
28 sensing area
29 elevator control
30 starting step
32 first deciding step—digit input ?
33 setting time-out timer
34 reading proximity sensor
36 second deciding step—hand moves away?
38 closing input channel from decade keyboard
40 transmitting floor number to elevator control
42 termination step
44 third deciding step—time-out?

1. A call input device of an elevator comprising:
a keyboard for inputting the number of a floor;
a keyboard control for the keyboard, wherein the keyboard control is configured to open an input channel from the keyboard for the input of a further digit of a floor number to enter a more than one-digit floor number; and
a proximity sensor having a sensing area in front of the keyboard,
wherein the keyboard control is configured to open/close the input channel from the keyboard for the input of a further digit in response to the signal of the proximity sensor.

2. The call input device according to claim 1, wherein the proximity sensor is configured to sense the direction of a movement in the sensing area and to close the input channel for the input of a further digit when the direction movement is sensed as being away from the keyboard.

3. The call input device according to claim 1, wherein the proximity sensor is configured to sense the direction of a movement in the sensing area and wherein the keyboard control comprises a clock circuit configured to be triggered by a push of a keyboard button to keep the input channel for the input of a further digit open when additionally the proximity sensor keeps sensing an object in the sensing area.

4. The call input device according to claim 1, wherein the keyboard comprises digit push buttons or touch fields.

5. An elevator with at least one elevator car driving in an elevator shaft, said elevator having more than ten floors and call input devices according to claim 1.

6. The elevator according to claim 5, said elevator having an elevator control with a destination call control.

7. A method for controlling a keyboard in an elevator call input device, comprising:
after the input of a digit is sensed, controlling an input channel of the keyboard to be open for the input of a further digit in response to sensor data of a proximity sensor having a sensing area thereof in front of the keyboard.

8. The method according to claim 7, wherein the input channel is closed when the proximity sensor senses an object leaving the sensing area.

9. The method according to claim 7, wherein the input channel is kept open for the input of a further digit when the proximity sensor senses an object remaining in the sensing area for a predefined time period.

10. The method according to claim 7, wherein the input channel is closed after a second or third digit has been input, whereafter the inputted digits are combined to a floor number which is transferred to the elevator control.

11. The call input device according to claim 2, wherein the proximity sensor is configured to sense the direction of a movement in the sensing area and wherein the keyboard control comprises a clock circuit configured to be triggered by a push of a keyboard button to keep the input channel for the input of a further digit open when additionally the proximity sensor keeps sensing an object in the sensing area.

12. The call input device according to claim 2, wherein the keyboard comprises digit push buttons or touch fields.

13. The call input device according to claim 3, wherein the keyboard comprises digit push buttons or touch fields.

14. An elevator with at least one elevator car driving in an elevator shaft, said elevator having more than ten floors and call input devices according to claim 2.

15. An elevator with at least one elevator car driving in an elevator shaft, said elevator having more than ten floors and call input devices according to claim 3.

16. An elevator with at least one elevator car driving in an elevator shaft, said elevator having more than ten floors and call input devices according to claim 4.

17. The method according to claim 8, wherein the input channel is kept open for the input of a further digit when the proximity sensor senses an object remaining in the sensing area for a predefined time period.

18. The method according to claim 8, wherein the input channel is closed after a second or third digit has been input, whereafter the inputted digits are combined to a floor number which is transferred to the elevator control.

19. The method according to claim 9, wherein the input channel is closed after a second or third digit has been input, whereafter the inputted digits are combined to a floor number which is transferred to the elevator control.
